(19) United States
(12) Patent Application Publication
(10) Pub. No.: US 2022/0258919 A1
(43) Pub. Date: Aug. 18, 2022

(54) PLASTIC CONTAINER WITH BARRIER

(71) Applicant: Plastipak Packaging, Inc., Plymouth, MI (US)

(72) Inventor: Ronald L. Uptergrove, Northville, MI (US)

(21) Appl. No.: 17/669,934

(22) Filed: Feb. 11, 2022

Related U.S. Application Data
(60) Provisional application No. 63/148,713, filed on Feb. 12, 2021.

(51) Int. Cl. B65D 23/08; B65D 1/02; B05D 7/00

(52) U.S. Cl. CPC B65D 23/0821; B05D 7/53; B65D 1/0246

(57) ABSTRACT

A plastic container includes a base portion, a sidewall portion, a neck portion, a barrier coating applied to at least portions of an outer surface of sidewall portion, and a protective layer printed or sprayed on at least portions of the barrier coating. In embodiments, the barrier coating may be applied via dip coating, spray coating, and/or drop on demand ink jetting (e.g., ink jet printing). In embodiments, a protective layer, or protective coating formulation, may be provided as part of a base coat, such as a clear coat, or as an additive in a base coat ink formulation and/or may be part of an ink jet decoration process.

### CROSS-REFERENCE TO RELATED APPLICATION

This application claims the benefit of U.S. Provisional Application No. 63/148,713, filed Feb. 12, 2021, which is incorporated herein by reference in its entirety.

### TECHNICAL FIELD

The present disclosure relates to plastic containers, including plastic containers having a barrier or external coating.

### BACKGROUND

Plastic containers may permit low molecular gases, such as oxygen and carbon dioxide, to slowly permeate through their physical configurations. In many cases, the shelf life of the product contents may be directly related to the package's ability to effectively address molecular permeation. In the case of carbonated beverages, oxygen in the atmosphere surrounding the container may gradually permeate inwardly through the plastic walls of the container to reach inside of the container and affect the contents. Likewise, carbon dioxide gas associated with the contents may permeate outwardly through the plastic walls of the container until eventually being released on the outside, causing the carbonated beverage to possibly lose some flavor.

To address some to the foregoing, plastic container manufacturers have utilized various techniques to reduce or eliminate the absorption and/or permeability of such gases. Some of the more common techniques include: increasing the thickness of all or portions of the walls of the container; incorporating one or more barrier layers into the wall structure; including oxygen-scavenging or reacting materials within the walls of the container; and applying various coatings to surfaces of the container.

There is, however, a desire to provide improved plastic containers that include barrier coatings and can address challenges associated with conventional packaging—such as oxygen transmission and CO₂ migration. There also a desire to provide barriers, methods, and articles that can address present challenges, and can do so in an efficient and cost-effective manner, both from a material cost and manufacturing perspective.

### SUMMARY

A plastic container includes a base portion, a sidewall portion, a neck portion, a barrier coating applied to an outer surface of the sidewall portion, and a protective layer applied to at least portions of the barrier coating. In embodiments, the barrier coating may be applied via dip coating, spray coating, and/or drop on demand ink jetting (e.g., ink jet printing). In embodiments, a protective layer, or protective coating formulation, may be provided as part of a base coat, such as a clear coat, or as an additive in a base coat ink formulation and/or may be part of an ink jet decoration process.

### BRIEF DESCRIPTION OF THE DRAWINGS

Embodiments of the disclosure will now be described, by way of example, with reference to the accompanying drawings, wherein:

FIG. 1 generally illustrates an embodiment of a plastic container in accordance with aspects and teachings of the present disclosure;

FIG. 2 is partial enlarged sectional view of a portion of the plastic container generally illustrated in FIG. 1; and

FIG. 3 is an enlarged partial sectional view of an embodiment of a portion of a sidewall of a plastic container in accordance with aspects and teachings of the present disclosure.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications, and equivalents, which may be included within the spirit and scope of the invention as defined herein and by appended claims.

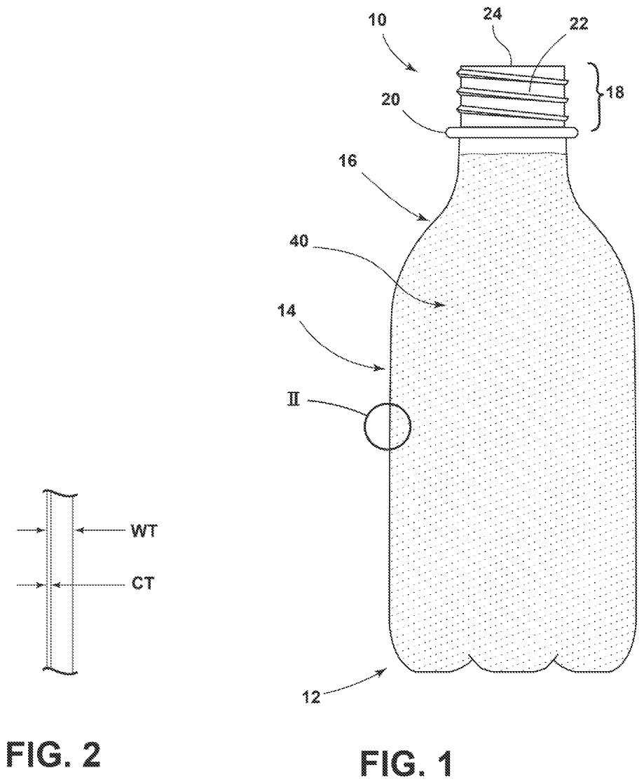

Among other things, the present disclosure is associated with plastic containers with barrier coatings, including CO₂ barrier coatings. A plastic container 10 may include a coating 40 disposed on at least a portion of an outer surface of the plastic container 10. An embodiment of a plastic container 10 with a coating 40 is generally illustrated in FIG. 1. The plastic container 10 may include a base portion 12, a sidewall portion 14 extending upwardly from the base portion 12, and a neck portion 18 extending upwardly from the shoulder portion 16. In embodiments, the sidewall portion 14 may include a shoulder portion 16 disposed below the neck portion 18. Although, some embodiments of plastic containers may not include a shoulder portion 16. The neck portion 18 may comprise, inter alia, a neck support flange 20, one or more threads 22, and an opening 24. For example and without limitation, a plastic container 10 may comprise a straight-wall, carbonated soft drink (CSD), 20-ounce container with a petaloid base.

In embodiments, the plastic container may comprise, for example and without limitation, polyethylene terephthalate (PET) or other plastic materials or polymers known in the field of plastic containers, and may comprise virgin and/or recycled content.

The coating 40 may comprise a barrier coating, and may comprise a CO₂ barrier coating. The coating 40 may be applied to an outer surface of the plastic container 10. With embodiments, the coating 40 may be applied to the outer surface of a plastic container. For example and without limitation, with embodiments a coating 40 may be applied to substantially the entire outer surface of the container or, less than substantially the entire outer surface (or select portions) of the container. For example and without limitation, with embodiments such as generally illustrated in FIG. 1, a coating may merely be applied below the neck portion 18, i.e., a coating may not be applied to the neck portion (e.g., from the underside of the neck support flange 20 up to the opening 24).

The coating 40 may, among other things, provide a barrier to CO₂ transmission, which can result in extended shelf life for coated containers when compared to similar uncoated containers.

FIG. 2 is partial enlarged sectional view of a sidewall portion 14 of the plastic container 10 generally illustrated in FIG. 1. As generally illustrated, a coating 40 is applied on the sidewall portion 14 of the plastic container 10. The sidewall portion 14 has a wall thickness WT and the coating 40 has a coating thickness CT, such as generally illustrated. In embodiments, the wall thickness WT may be a number of times greater than the coating thickness CT. For example and without limitation, WT may be at least five times CT.

A coating 40 can be applied to outer surfaces of plastic containers via various methods or processes. A coating may be applied, for example and without limitation, via dip coating, spray coating, and/or drop on demand ink jetting (e.g., ink jet printing). Moreover, with embodiments, a coating formulation may be provided as part of a base coat, such as a clear coat, or as an additive in a base coat ink formulation (e.g., in a UV ink formulation) and/or may be part of an ink jet decoration process such as those known in the field. Teachings associated with digital printing and base coats are provided, for example, in U.S. Pat. No. 9,150,325; 8,876,979, and 8,522,989, all of the foregoing being hereby incorporated by reference as though fully set forth herein.

With embodiments, various polymers (such as identified below) may be provided as an outer layer (as a barrier coating), and at differing concentrations (e.g., 10%, 15%, and/or 30%) by weight mixed into a liquid solvent—such as methyl ethyl ketone (MEK) solution. Such polymers for the coating may, for example, comprise:
polyvinylidene fluorides (PVDF)
polyamide resins
ethylene vinyl alcohol (EVOH)
   With an EVOH embodiment, a further outer layer (or protective layer), such as a monomer-based (e.g., a clear coat), may be included to also provide a moisture barrier. Different blends and/or concentrations of such barrier coating and/or protective layer materials may provide different physical properties.

Once mixed and completely in solution, plastic containers (or at least a portion of a sidewall portion thereof) may be coated (e.g., with a barrier coating) and dried. The drying process may be functionally or operationally expedited, or may simply be the result of ambient conditions over time. After a coating dries, the plastic containers may demonstrate improved functional characteristics.

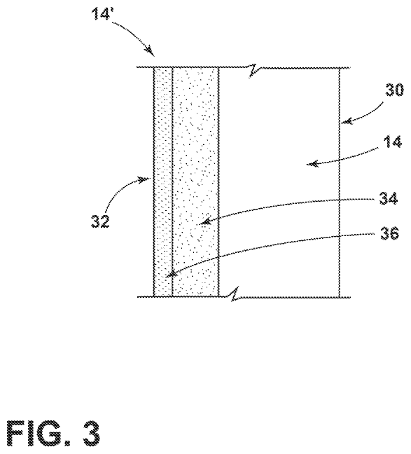

FIG. 3 generally illustrates an enlarged partial sectional view of an embodiment of a portion of a sidewall 14′ of a coated plastic container (i.e., a plastic container including a barrier layer). An inner wall 30 and an outer wall 32 of a coated plastic container are generally identified. As generally illustrated, a sidewall portion 14 of a container 10 may include a barrier layer 34 provided on an outer surface of a sidewall portion 14, and a protective layer 36 provided on the outer surface of the barrier layer 34. In embodiments, the protective layer 36 may comprise a monomer (e.g., a monomer base coat), may be printed (e.g., digitally printed) or sprayed on all or portions of a barrier layer, and may, depending on the content of the protective layer, be cured (e.g., UV-cured). With embodiments, coatings—e.g., the barrier layer(s) and, if applicable, protective layer(s)—may be removable in recycling, and the whole container may be recyclable.

An embodiment of a method for making a plastic container with a barrier includes:
(i) providing a plastic container having a base portion, a sidewall portion extending upwardly from the base portion, a neck portion extending upwardly from the sidewall portion;
(ii) applying a barrier coating on at least a portion of an outer surface of the sidewall portion; and
(iii) applying, via printing or spraying, a protective layer or protective coating on at least portions of the barrier coating.

With embodiments, the plastic container may be comprised of, for example and without limitation, polyethylene terephthalate (PET) or other appropriate polymers. A barrier coating, of for example an EVOH formulation, may be applied (e.g., via spraying or printing) to at least a portion of the sidewall of the plastic container. The barrier coating may be permitted to dry or dried (e.g., naturally or via a drying process), and a protective layer or coating—which may comprise a monomer-based coating or formulation—may be applied over at least portions of the barrier coating and, if desired or appropriate, may be cured (e.g., UV-cured).

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A plastic container, comprising:
a base portion;
a sidewall portion extending upwardly from the base portion;
a neck portion extending upwardly from the sidewall portion;
a barrier coating on at least a portion of an outer surface of the sidewall portion; and
a protective layer printed on at least a portion of the barrier coating.

2. The plastic container of claim 1, wherein the sidewall portion includes a shoulder portion disposed below the neck portion.

3. The plastic container of claim 1, wherein the neck portion includes a neck support flange, one or more threads, and an opening.

4. The plastic container of claim 1, wherein the plastic container comprises polyethylene terephthalate (PET).

5. The plastic container of claim 1, wherein the plastic container comprises recycled plastic.

6. The plastic container of claim 1, wherein the barrier coating comprises a CO₂ barrier coating.

7. The plastic container of claim 1, wherein the barrier coating is disposed on substantially the entire outer surface of the container below the neck portion.

8. The plastic container of claim 1, wherein the barrier coating is disposed on select portions of the outer surface of the container.

9. The plastic container of claim 1, wherein the sidewall portion has a wall thickness, the barrier coating has a coating thickness, and the wall thickness of the sidewall portion is more than two times greater than the thickness of the barrier coating.

10. The plastic container of claim 1, wherein the sidewall portion has a wall thickness, the barrier coating has a coating thickness, and the wall thickness of the sidewall portion is at least five times greater than the thickness of the barrier coating.

11. The plastic container of claim 1, wherein the barrier coating is printed via ink jet printing or drop on demand ink jetting.

12. The plastic container of claim 1, wherein the barrier coating comprises a base coat.

13. The plastic container of claim 1, wherein the barrier coating includes a clear coat.

14. The plastic container of claim 1, wherein the barrier coating includes an additive.

15. The plastic container of claim 1, wherein the barrier coating includes a UV ink formulation.

16. The plastic container of claim 1, wherein the protective layer comprises a polymer provided at a concentration by weight mixed into a solvent.

17. The plastic container of claim 16, wherein the solvent comprises methyl ethyl ketone (MEK) solution.

18. The plastic container of claim 16, wherein the polymer of the protective layer comprises one of more of the following: polyvinylidene fluoride (PVDF), polyamide resin, or ethylene vinyl alcohol (EVOH).

19. A plastic container, comprising:
a base portion;
a sidewall portion extending upwardly from the base portion;
a neck portion extending upwardly from the sidewall portion;
a barrier coating on at least a portion of an outer surface of the sidewall portion; and
a protective layer sprayed on at least portions of the barrier coating.

20. A method for making a plastic container, the method comprising:
providing a plastic container having a base portion, a sidewall portion extending upwardly from the base portion, a neck portion extending upwardly from the sidewall portion;
applying a barrier coating on at least a portion of an outer surface of the sidewall portion;
applying, via printing or spraying, a protective layer on at least portions of the barrier coating.

21. The method of claim 20, wherein the barrier coating comprises an EVOH formulation.

22. The method of claim 20, wherein the protective layer comprises a monomer-based formulation that is cured.
